(19) United States
(12) Patent Application Publication
(10) Pub. No.: US 2010/0026756 A1
(43) Pub. Date: Feb. 4, 2010

(54) DEVICE FOR CLEANING WIPING ELEMENTS FOR AN INK PRINT HEAD

(76) Inventor: Frank Geserich, Friedrichsthal (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/500,704

(22) Filed: Jul. 10, 2009

(30) Foreign Application Priority Data
Jul. 30, 2008 (DE) 102008 035 679.4

(51) Int. Cl. B41J 2/165

(52) U.S. Cl. 347/31; 347/33

(57) ABSTRACT

A device cleans wiping elements for an ink print head of an ink dispensing apparatus that has a print carriage on whose base plate a stripper element is integrally formed, an immovably situated wiping lip mount that supports wiping lips that are cleaned by the stripper element. At least one ink absorber is situated in a holder, close to the rear side of a cowling carriage of the ink printing apparatus. The stripper element of the print carriage is located opposite the at least one ink absorber during the maintenance interval, in a position that is reached when a segment of the stripper element of the print carriage comes to abut the entraining hook of the cowling carriage. The at least one ink absorber designed for cleaning the stripper element is pushed partially over the stripper element by movement of the cowling carriage.

### BACKGROUND OF THE INVENTION

1. Field of the Invention

The present invention relates to a device for cleaning wiping elements for an ink print head of an ink dispensing apparatus. The present invention is suitable for an ink printing device of the type used in mail processing machines, addressing machines, and postage meter machines, as well as other ink printing devices.

2. Description of the Prior Art

European patent application EP 885 726 A1 discloses the use is known of a sponge element in a postage meter machine of the Jetmail® type, the sponge being fastened to the print head and being used to wipe off the wiping lips that are situated on a carriage of a cleaning and sealing station. This solution is expensive, because in comparison with the HP print head, the print head surface of the special Jetmail® print head is much larger, so that a larger quantity of ink collects there, which has to be wiped away and absorbed by the sponge. Due to this large quantity of ink, the absorption capacity of the sponge is soon exceeded, and time-intensive and cost-intensive maintenance measures are necessary in order to suction the excess ink on the sponge element.

Many commercially available postage meter machines using inkjet technology use print heads manufactured by Hewlett-Packard, and use components known as wiping elements to remove the excess ink from the print head. Here, either the print head travels over a stationary wiping element or the wiping element travels over the stationary head. The excess ink is carried along by the wiping element and is stripped off by stripper elements (doctor blades). Because the HP print heads have a relatively small print head surface, this is usually sufficient.

From European patent application EP 1 782 954 A1, a device is known for cleaning an ink print head for a postage meter machine of the type Centormail®. The ink print head is a component of each ink cartridge. Two ink cartridges are exchangeably situated in a receptacle. The receptacle can be pivoted into a print position, so that during printing the ink print head is situated in stationary fashion in a print window of a guide plate for the flat postal items (print media). A cleaning and sealing station is used as a maintenance station, and is also adjustably situated behind the guide plate, and can be moved toward the ink print head and away from it. A stripper is arranged separately from the print head or its mount, on a stripper mount that is fastened to the chassis. Two strippers are used to wipe off the wiping lips that are situated on a carriage of a cleaning and sealing station when the carriage is moved away from the ink print head back into its initial position.

The postal requirements for digital readability of a postage meter imprint should also be reliably satisfied for other postage meter machine types. It has been empirically determined that the strippers previously used in the postage meter machine of the Ultimail® type are often not sufficient for the cleaning of the wiping lips, so that ink residues dry on the wiping elements. In various ways, the dried-on ink has contamination effects during a new wiping over the wet heads; these effects reduce the print quality or may result in failure of the print head.

It can also be observed that deterioration of the print quality occurs if a very large quantity of ink comes onto the wiping elements in a short period of time, for example as a result of frequent cleaning due to the operating mode.

The device that is to be improved for cleaning wiping elements for an ink print head of an ink dispensing means has a print carriage on whose base plate a stripper element is integrally formed. A wiping lip mount, situated immovably on the chassis, supports the wiping lips and can be cleaned by a stripper element when the print carriage is moved from a print position in the y direction, i.e. orthogonal to transport direction x for postal items. Instead of a cleaning and sealing station, a cowling carriage is also used that is capable of movement orthogonal to the transport direction x, i.e. in the y and z directions of a Cartesian coordinate system, having an entraining hook and having lateral guide pins on the cowling carriage, guided in a slotted guide bar.

During travel of the at least one print head before a print position has been reached, the nozzle surface of the at least one print head is wiped off by a respective wiping element. A wiping element can be cleaned by the stripper, which in the Ultimail® postage meter machine is realized as a doctor blade and is situated on the underside of a print carriage. The doctor blade then strips off the excess ink during the continued travel before a print position is reached.

Empirically, it has been found that after a certain number of cleaning cycles have taken place over time, the self-cleaning capacity of the stripper is clearly exceeded, and the wiping elements can no longer be adequately cleaned. One solution of this problem could be to minimize the number of cleaning cycles. However, a reduction of the cleaning cycles can result in drying out of a print head in the case of postage meter machine users who have low mail volume and who therefore meter postal items in stacks less frequently, or who meter individual postal items only at large temporal intervals. Therefore, a device is needed for cleaning wiping elements that make an additional contribution to the removal of old ink from the maintenance system having the components stripper and wiping lip. It would be possible to use an additional stripper, but this would require modification of the construction of the print carriage required for the transport of the at least one print head. This would also result in a considerable expense, disproportionate to the benefit.

### SUMMARY OF THE INVENTION

An object of the present invention is to avoid the deposition and drying on of excess ink residue on the wiping elements of a device for cleaning wiping elements for an ink print head of an ink dispensing apparatus.

The solution to the problem in accordance with the invention proceeds from the assumption that adequate cleaning of the wiping elements during a maintenance operation requires a clean stripper element. In the travel path of the print carriage, a position has been established for carrying out the function of cleaning the stripper and absorbing old ink.

The aforementioned position must not be coupled with the position during the wiping off of the wiping elements in the maintenance interval. The position should be stopped at at least when needed, if for example many cleaning intervals have already taken place in a short time interval.

The above object is achieved for a device of the last-described type above, having in accordance with the invention an ink absorber that wipes off excess ink and accommodates the wiped-off ink passively in its interior, and that is situated in a holder at a distance in the y direction from the rear side of the cowling carriage, i.e. at a position situated opposite the stripper (doctor blade), immediately before the sealing position is reached. The ink absorber is at least one exchangeable sponge element, or some other material suitable for absorbing ink.

The removal of old ink from the maintenance system with stripper and wiping lip has been advantageously realized with economical means, so that the wiping lips are not constantly further contaminated.

At least one ink absorber is situated close to the rear side of the cowling carriage in a holder, such that during the maintenance interval the stripper element of the print carriage is situated opposite the ink absorber when a center segment of the stripper element of the print carriage comes into contact with the entraining hook of the cowling carriage. The stripper element is now able to carry out the function of cleaning the stripper edge.

The cowling carriage is fashioned so as to be movable toward and away from the print carriage in the z direction, by lateral guide pins guided in a slotted guide bar, while the print carriage is moved further in the y direction. Here, the at least one ink absorber, designed for the cleaning of the stripper element, is pulled partially over the stripper element by the aforementioned movement of the cowling carriage. The ink absorber is formed of a material suitable for absorbing old ink. The holder of the ink absorber is situated on the cowling carriage in the print path of the at least one ink print head, and can be realized either as an integrated component of the cowling carriage or as a separate assembly that can be coupled to the cowling carriage.

For the Ultimail® postage meter machine, a sponge holder has been developed that can easily be coupled to the existing cowling carriage, the cowling carriage being moved under the stripper element (doctor blade) when the print carriage travels. The excess ink is removed by the wiping elements during the travel of the print carriage into the printing position after the wiping of the at least one print head by the wiping elements. During the travel of the print carriage from the print position into a maintenance position, there also takes place a cleaning of the wiping elements by means of the doctor blade. The excess ink is removed from the doctor blade, preferably by the sponge, when the print carriage travels from the print position into a separate sealing position, or travels further, or is moved back-and-forth there. The sponge element binds the excess ink through suction, on the basis of the known capillary effect. A clean doctor blade can ensure that the wiping elements wipe over the print heads only in the clean state. Software has also been created that allows the aforementioned position to be assumed as needed, or in the maintenance interval. The wiping on demand is initiated by the user via the already-existing user interface, for example when the print quality has deteriorated.

### BRIEF DESCRIPTION OF THE DRAWINGS

FIG. 1a shows a perspective view of the known postage meter machine of the Ultimail® type, from the top front.

FIG. 1b is a sectional side view of the Ultimail® from the right, showing elements of the print device in a position during printing.

FIG. 2a is an exploded perspective view of the cowling carriage and of the ink absorber with a holder, from the front top right.

FIG. 2b is a perspective view from the front top right of a cowling carriage equipped with ink absorber.

FIG. 3a is a front view of the sponge holder.

FIG. 3b is a side view from the left of the sponge holder.

FIG. 3c is a top view of the sponge holder.

FIG. 4a is a side view from the right of elements of the print device, with the at least one print head in the print position.

FIG. 4b is a side view from the right of elements of the print device with the print carriage upon arrival at the position for cleaning the wiping elements by the stripper.

FIG. 4c is a side view from the right of elements of the print device with the print carriage upon arrival at the position for cleaning the at least one print head by the wiping elements.

FIG. 4d is a side view from the right of elements of the print device with the print carriage upon arrival at the position for the entrainment of the cowling carriage.

FIG. 4e is a side view from the right of elements of the print device with the print carriage in the sealing position.

FIG. 5 is a sequence flow chart upon leaving the print position.

### DESCRIPTION OF THE PREFERRED EMBODIMENTS

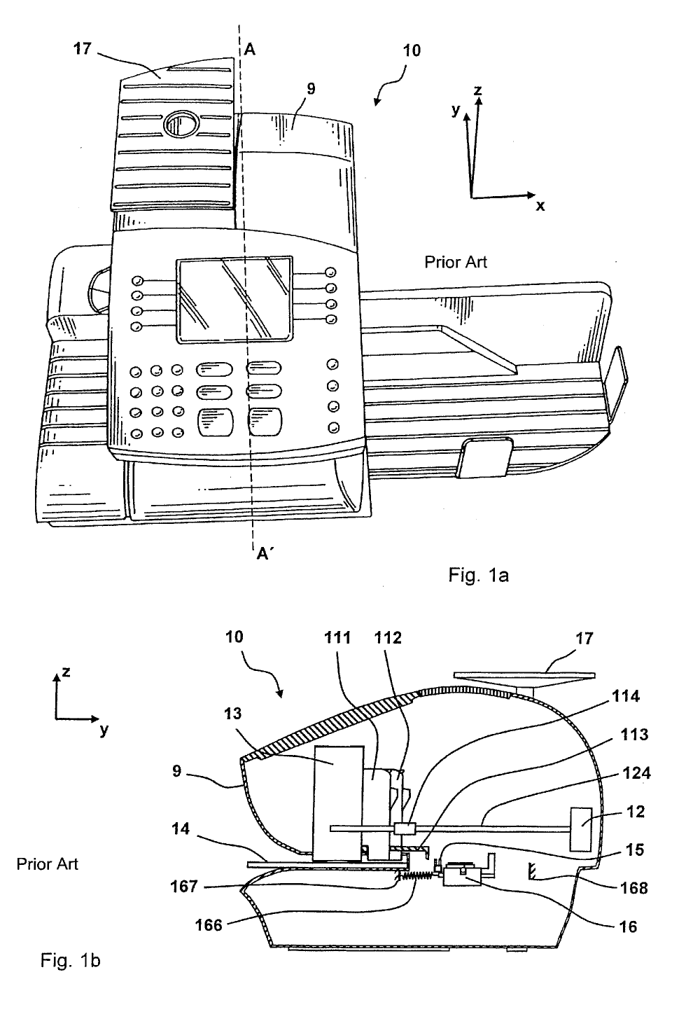

FIG. 1a shows a perspective view from the front top of the known postage meter machine of the Ultimail® type. The left side is the mail entrance side, and the right side is the mail exit side for flat postal items or for other suitable print media. The postal items (not shown) are supplied lying on their side. The transport of the postal items takes place along the x direction of a Cartesian coordinate system. Postage meter machine 10 extends orthogonally thereto on the one hand toward the rear in the y direction and on the other hand upward in the z direction, i.e., against the force of gravity. The postage meter machine has a housing 9 and a weighing plate 17 that is situated in the rear part, on the upper side at left. In the following FIG. 1b, the housing is shown in section along the line AA′.

FIG. 1b shows a sectional side view of the Ultimail® from the right, with a simplified representation of elements of the print device in a position during printing. A postage meter machine 10 has a print carriage (not shown completely for simplicity) capable of travel in the y direction, having at least one print head. The print head can be a component of an ink cartridge. For example, for printing two ink cartridges 111, 112 and a transport drum 13 for flat postal items 14 are used. In the print position, the underside of each of ink cartridges 111, 112 is situated in the cavity of transport drum 13. More details concerning this can be found in European patent EP 1 170 141 B1 and the corresponding U.S. Pat. No. 6,467,901.

Housing 9 of postage meter machine 10 and a base plate 113 of the print carriage are shown in section in simplified form.

The print carriage on its base plate 113 supports a doctor blade for stripping off wiping lips. The elements of the print device include a wiping lip mount 15 fastened to the chassis, a cowling carriage 16 that can travel in the y and z directions, and a tensile spring 166 which is fastened to the chassis at point 167 and is fastened to cowling carriage 16. Cowling carriage 16 travels in the y direction against the spring force of tensile spring 166 when the print carriage moves into immediate mechanical contact with cowling carriage 16. Cowling carriage 16 can travel up to a stationary stop 168. This is accomplished via the print carriage, in that the print carriage is driven by a motor 12 via a spindle 144. On spindle 124 there is situated a sleeve 114 having an inner threading that is coupled (in a manner not shown) to the print carriage, or is a component of the print carriage.

In an alternative variant of the postage meter machine, weighing plate 17 may be omitted.

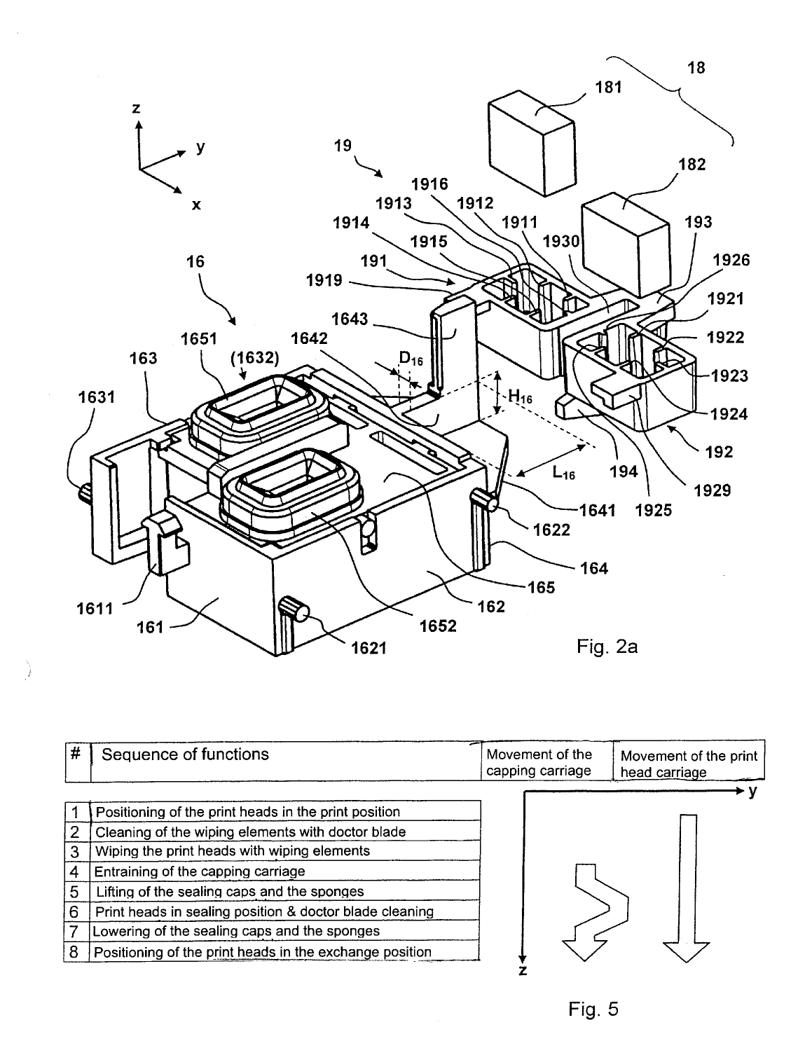

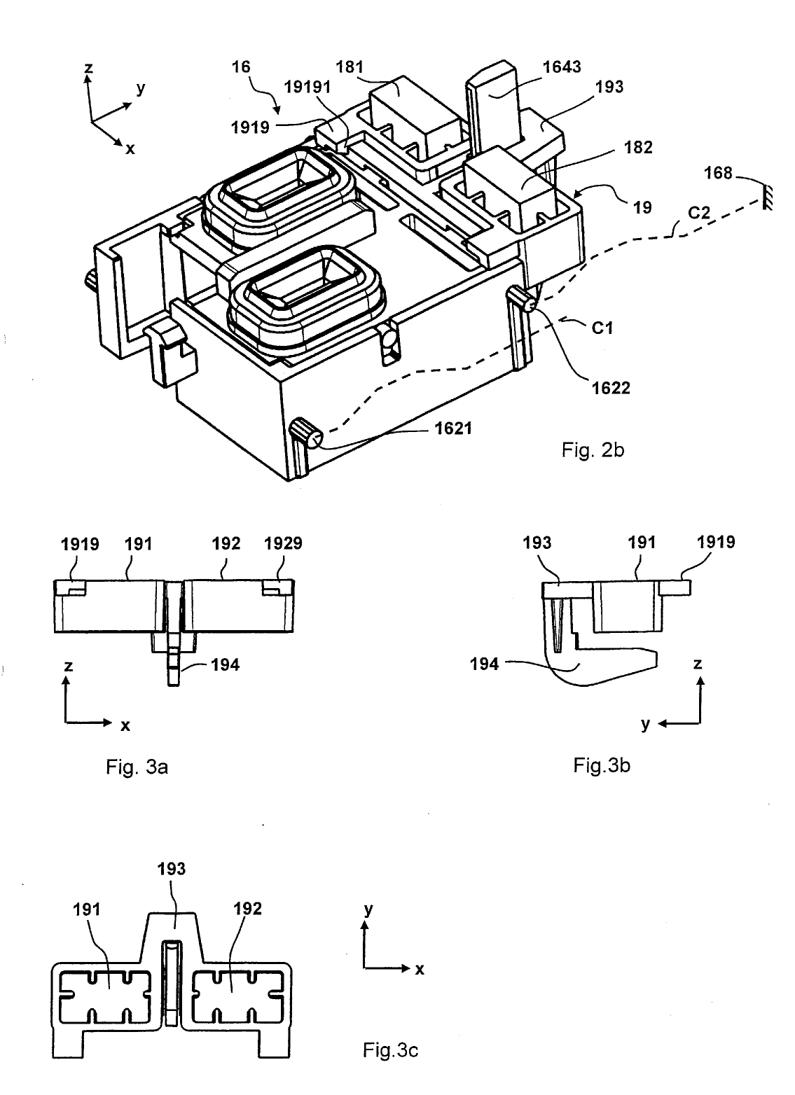

FIG. 2a is an exploded perspective view of cowling carriage 16 and of ink absorber 18 having a holder 19 at the front top right. Artificially produced sponges 181, 182 are for example suitable for use as ink absorber 18, and holder 19 for the ink absorber is likewise preferably made of an artificially produced material, preferably of the same material as cowling carriage 16. Cowling carriage 16 has a box-shaped design, having a coupling element 1611 for the tensile spring (not shown) on a front wall 161, having guide pins 1621, 1622 on a right side wall 162, and having guide pins 1631, (1632 hidden) on a left side wall 163. The cowling carriage 16 also has a rear wall 164 that has a plate 1641 that tapers in the y direction in the shape of a trapezoid or a wedge, and an entraining hook-shaped fin 1642 that extends in the z direction. The plate 1641 has on its upper side a trapezoidal or wedge-shaped formed surface parallel to the x/y direction, on which the entraining fin 1642 is integrally formed in the center, parallel to the z/y direction. Entraining fin 1642 has a thickness D₁₆, and at its end remote from rear wall 164 it goes over into a hook 1643, which is angled off orthogonally in the z direction, and which has the same thickness, corresponding to thickness D₁₆.

Cowling carriage 16 has on its surface a flexibly mounted plate 165 having at least one sealing cowling 1651, 1652, the sealing cowling preferably being made of rubber and having an edge that is curved in the z direction. In the preferred exemplary embodiment, two sealing cowlings 1651, 1652 are provided for the ink print heads of two ink cartridges, sealing cowlings 1651, 1652 being offset to one another in the y direction.

Holder 19 of ink absorber 18 has a clip 193 and a respective bracket 191, 192 allocated to the print path of a respective ink print head, the cavity of each bracket being adapted in its dimensions to the dimensions of ink absorber 18. Each of the two ends of clip 193 is connected to a respective bracket 191, 192, and the clip has in the y direction a slot 1930 that has a width corresponding to thickness D₁₆, and that has a length corresponding to length L16 of entraining fin 1642, the clip limiting the length of the slot at the one end oriented in the y direction, and the other end of slot 1930 remaining open for coupling to cowling carriage 16, and being expanded in the shape of a funnel. The depth of the slot, or the height of brackets 191, 192 in the z direction, corresponds to height H₁₆ of entraining fin 1642 of cowling carriage 16. At the closed end of slot 1930, on the underside of clip 193 a claw 194 bent in the shape of a hook is integrally formed that is supported on the trapezoidal or wedge-shaped surface of the underside of plate 1641 during coupling to cowling carriage 16.

Each bracket 191, 192 has a round-to-quadrangular base shape, and has an edge strip that is smooth on its external side and that has pin-shaped bars on its inner side as holding means. Alternatively, similar to the holding and exchanging of ink absorber 18, suitably structured holders 1911 to 1916 and 1921 to 1926 can be used. Respective coupling elements 1919, 1929 are integrally formed on the external sides of the smooth edge strip of brackets 191, 192, opposite the y direction, these coupling elements 1919, 1929 being matched to the shape of cowling carriage 16. Coupling elements 1919, 1929 are matched to the lateral corners of rear wall 164 and to the upper edge of side walls 162, 163. A snap-in connection is provided. Alternatively, of course, different positive and non-positive connections are also possible.

FIG. 2b shows a perspective view from the front top right of a cowling carriage equipped with ink absorber 18. Cowling carriage 16 carries two synthetically produced sponges 181, 182 as ink absorber 18 at both sides of clip 193, through whose slot hook 1643, angled off from entraining fin 1642, extends upward in the z direction. Coupling element 1919 supports a wedge-shaped hook 19191. Coupling element 1929 (not visible) has the same design. Guide pins 1621, 1622 are used to guide the cowling carriage 16, preferably by means of a slotted guide bar (not shown). The guiding takes place on two different paths having a comparable curved shape, shown in broken lines. First guide pin 1621 executes a first curve C1, and second guide pin 1622 executes a second curve C2; these curves run offset to each other in the y and z direction. The end of second curve C2 is fashioned as stop 168 for the cowling carriage.

Although, in the example presently shown, holder 19 is realized so as to be removable or pluggable, this is not intended to exclude a variant embodiment in which both cowling carriage 16 and holder 19 have been produced from one piece, or in an injection molding method. Coupling elements 1919, 1929, and the claw (hidden) can then of course be omitted.

FIG. 3a shows a front view of the sponge holder with brackets 191, 192, coupling elements 1919, 1929, and claw 194.

FIG. 3b shows a side view of the sponge holder from the left, with left bracket 191, coupling elements 1919, and claw 194 on clip 193.

FIG. 3c shows a top view of the sponge holder, with brackets 191, 192 and clip 193.

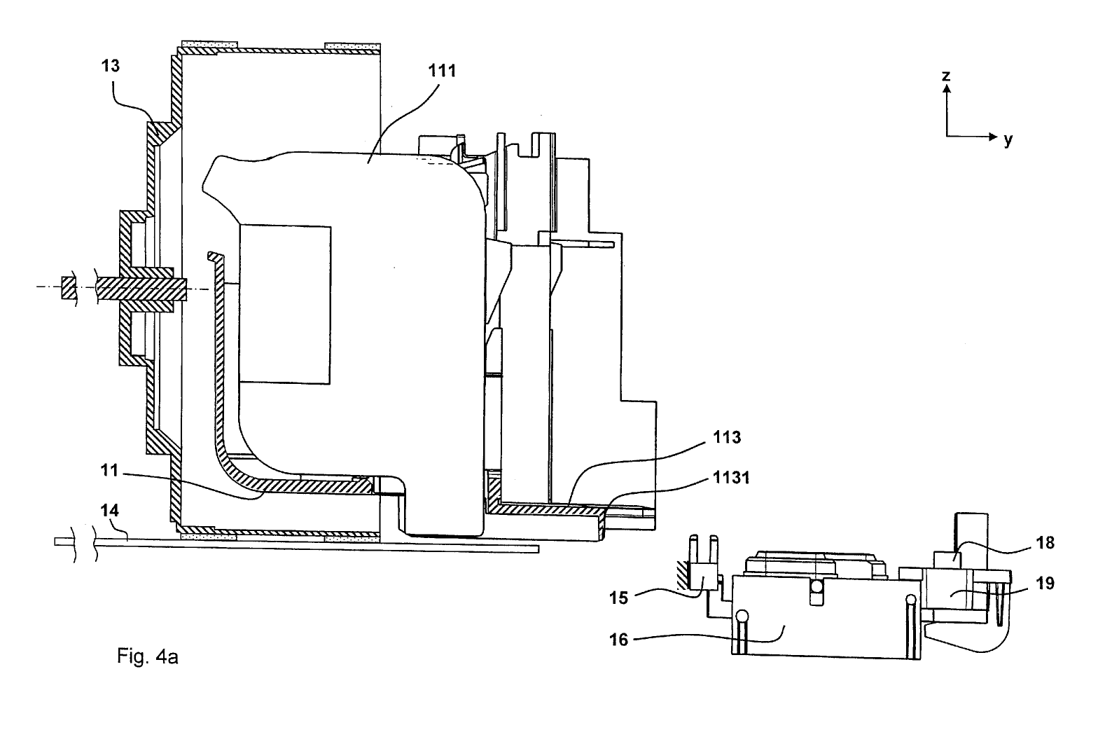

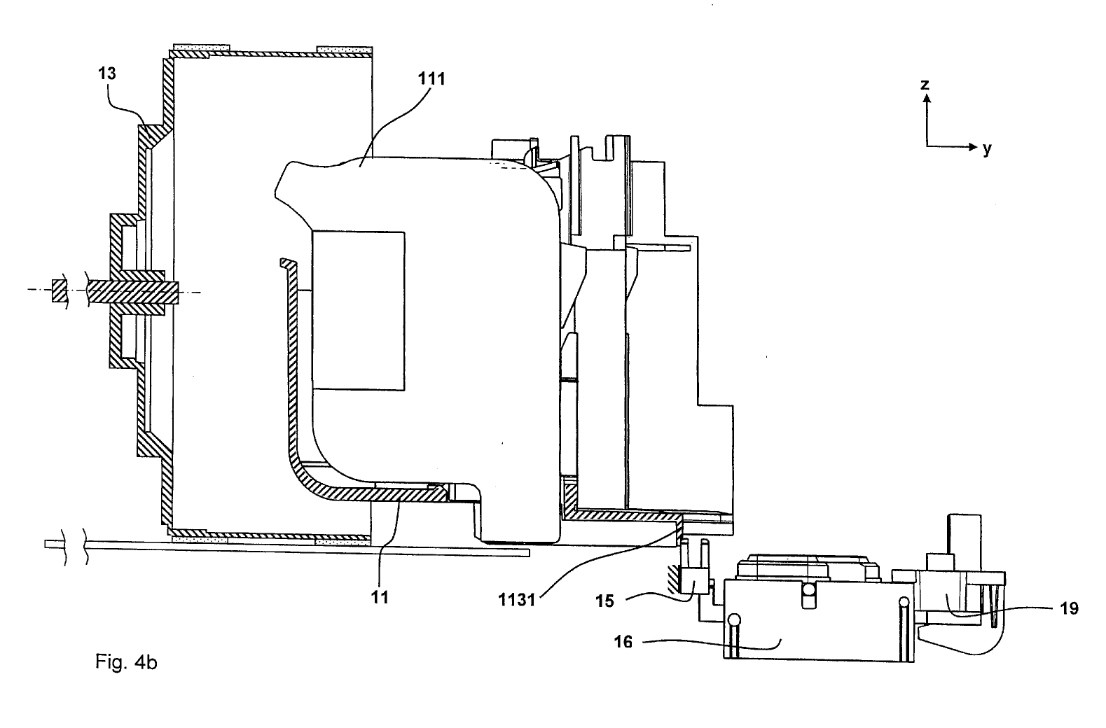

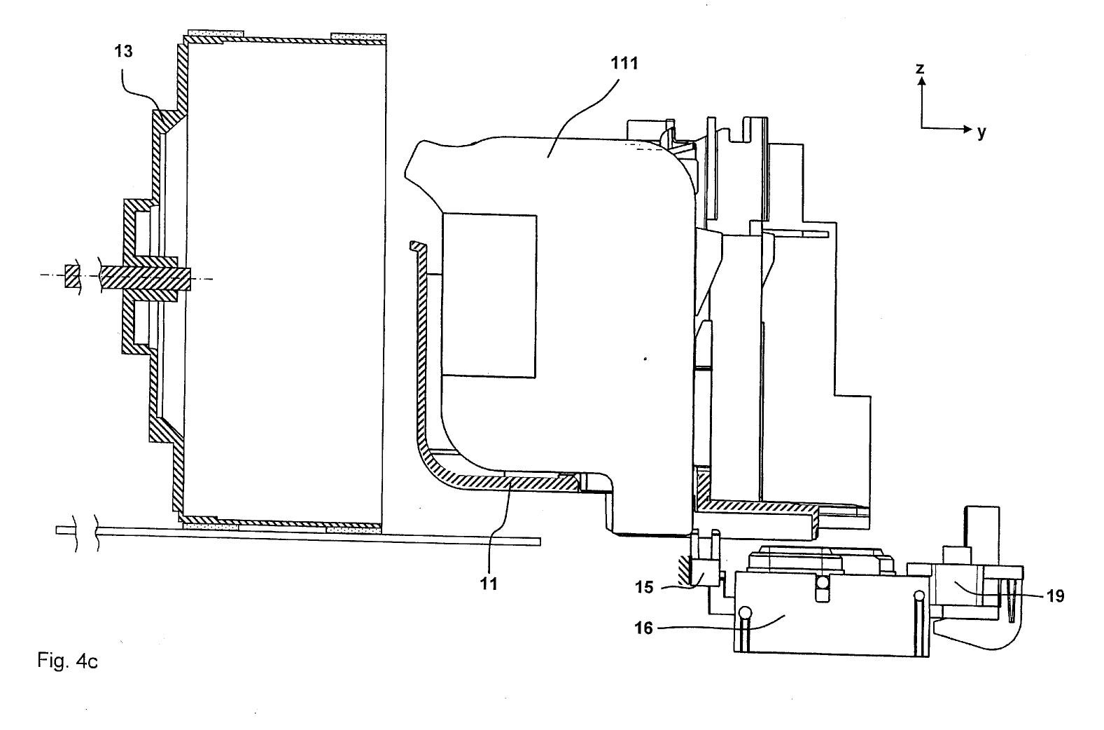

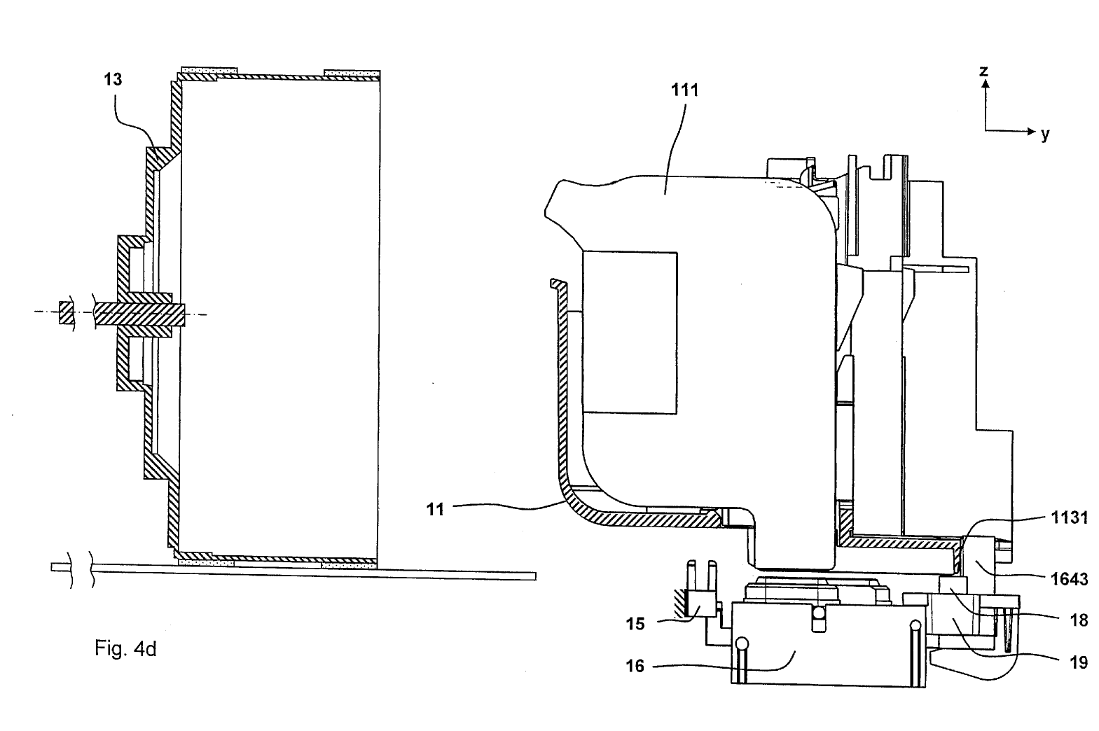

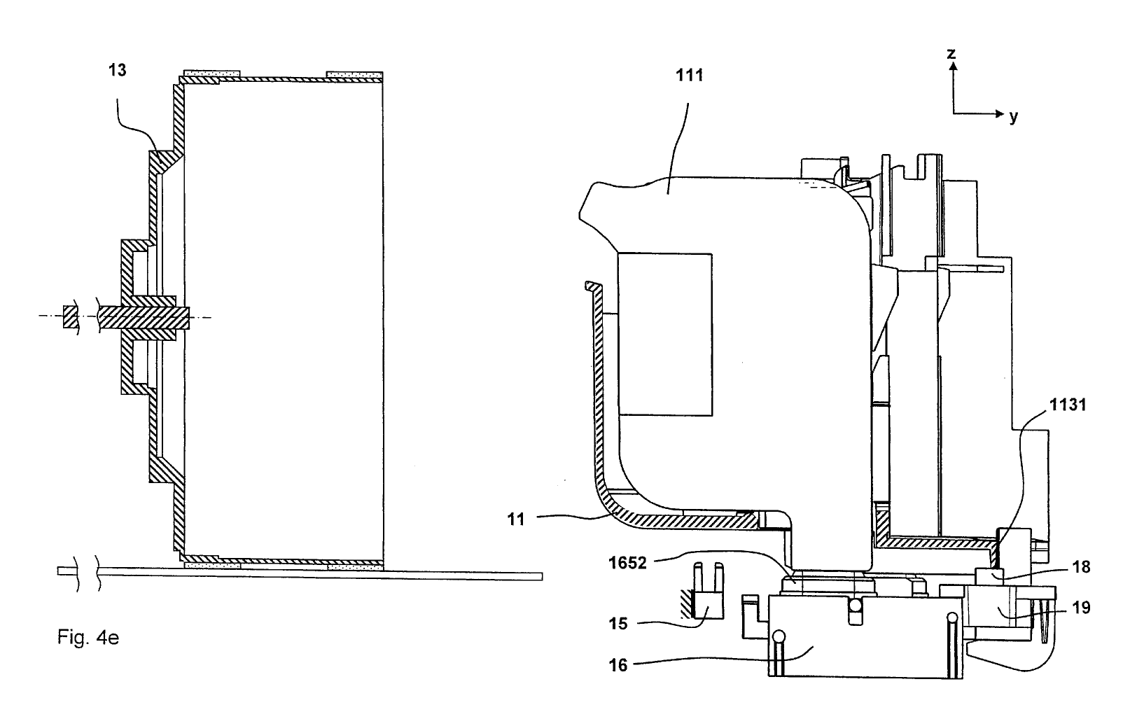

FIG. 4a shows a top view of elements of the print device from the right, with the at least one print head in the print position. Print drum 13 and print carriage 11 are shown in section, so that right ink cartridge 111 is visible. The print head is a component of the right ink cartridge 111, and is oriented downward, toward the surface of a postal item 14. Base plate 113 of print carriage 11 supports, as stripper element 1131, a doctor blade that is oriented in the same direction as the print head, i.e. downward. Cowling carriage 16 is connected to holder 19 of ink absorber 18, and is positioned in the initial position, close to wiping lip mount 15.

FIG. 4b shows a side view of elements of the print device from the right, with the print carriage, upon reaching the position for cleaning wiping elements by means of the stripper, during the further travel of print carriage 11 in the y direction. Print drum 13 and print carriage 11 are again shown in section, so that right ink cartridge 111 is visible, its print head being oriented downward, as is stripper element 1131 formed integrally on print carriage 11. Excess ink that may be present on the wiping lips of wiping lip mount 15 can thus be stripped off by stripper element 1131 while print carriage 11 continues to move in the y direction.

The position of cowling carriage 16, connected to ink absorber holder 19, is unchanged; it remains in the initial position close to wiping lip mount 15.

FIG. 4c shows a side view of elements of the print device from the right, with the print carriage, upon reaching the cleaning position for the at least one print head, for the cleaning thereof by means of wiping elements during the continued travel of print carriage 11 in the y direction. Transport drum 13 and print carriage 11 are again shown in section, so that right ink cartridge 111 is visible, which has been moved out of the interior of transport drum 13, and whose print head is wiped by the wiping lips of wiping lip mount 15 while print carriage 11 continues to move in the y direction.

Cowling carriage 16, connected to ink absorber holder 19, continues to be positioned in the initial position close to wiping lip mount 15.

FIG. 4d shows a side view of elements of the print device from the right, with the print carriage, upon reaching the position for the entraining of the cowling carriage 16 during the continued travel of print carriage 11 in the y direction. Print drum 13 and print carriage 11 are again shown in section, so that right ink cartridge 111 is visible, whose print head moves into a position over the associated sealing cap, while print cartridge 11 continues to move in the y direction. Stripper element 1131 abuts entraining hook 1643. Cowling carriage 16, which is connected to holder 19 for ink absorber 18, and which is still positioned in the initial position close to wiping lip mount 15, is carried along by print carriage 11 while print carriage 11 continues to move in the y direction.

FIG. 4e shows a side view of elements of the print device from the right, with the print carriage, in the sealed position during the continued travel of print carriage 11 in the y direction. Transport drum 13 and print carriage 11 are again shown in section, so that right ink cartridge 111 is visible, whose print head remains in a position over the associated sealing cap 1652, because cowling carriage 16, connected to the holder 19 for ink absorber 18, is carried along with print carriage 11. Cowling carriage 16 is lifted in the z direction by a slotted guide bar (not shown), while print carriage 11 continues to move in the y direction. Ink absorber 18 is partially pulled over stripper element 1131 when ink absorber holder 19 of cowling carriage 16 moves toward print carriage 11. When the print carriage is moved further in the y direction, into a position (not shown) for exchanging the ink cartridge, cowling carriage 16 is then lowered opposite the z direction by the guide bar (not shown), and stripper element 1131 is again separated from ink absorber 18, and is thus cleaned.

FIG. 5 shows a sequence flow plan upon leaving the printing position. In each step, a particular function is executed. In a first step 1, there takes place a positioning of the print heads in the print position (FIG. 4a). In a second step 2 there takes place a cleaning of the wiping elements using a doctor blade (FIG. 4b). In a third step 3 there takes place a wiping off of the print heads using wiping elements (FIG. 4c).

In a fourth step 4 there takes place an entraining of the cowling carriage (FIG. 4d). In a fifth step 5 there takes place a lifting of the sealing caps and of the sponges (FIG. 4e). In a sixth step 6, a doctor blade cleaning takes place while the print heads are positioned in a sealing position over cowling carriage 16. In a seventh step 7, the sealing cowlings and the sponges are lowered, while the print carriage continues to move in the y direction, into a position for the exchanging of the ink cartridge. There subsequently follows, in an eighth step 8, a positioning of the print heads in the exchange position. During a maintenance interval, these steps can also be executed in the reverse sequence.

Ink absorber 18 is preferably made of a synthetically produced sponge, but naturally occurring suitable materials are not precluded. Because the ink dispensing apparatus has two print heads, two artificially produced sponges 181, 182 are used as ink absorber 18; these are situated in holder 19 with an offset to one other in the x direction. The construction of the ink absorber 18 is matched to the shape of stripper element 1131, so that it is suitable for the wiping thereof. In the present exemplary embodiment, a rear lower edge of the print carriage is shaped as a stripper element 1131 extending parallel to the x direction. Only a single stripper element 1131 exists, although two wiping lip mounts for the print heads, which heads are offset to one another opposite the x direction and in the y direction, are also positioned offset to each other in the same manner (not shown). Cowling carriage 16 has between its left side wall 163 and coupling element 1611 a recess (FIG. 2a) for accommodation of a second wiping lip mount (not shown) that is also arranged on the chassis in stationary fashion but offset opposite the x direction and in the y direction.

The printing carriage 11, when it has traveled into a sealing position for the print heads, is situated opposite cowling carriage 16, and that simultaneously each of the two sponges 181, 182 is situated opposite a stripper segment, the stripper segment being situated next to the center segment of stripper element 1131, the center segment of stripper element 1131 acting as a stop on entraining hook 1643 and the stripper segments of the stripper element acting as doctor blades. Sponge elements 181, 182 can be made from an ecologically degradable, synthetically produced material.

Alternatively to the present specific embodiment, it is of course also possible to use an equivalent ink absorber 18 made of some other, possibly natural, material having similar properties. For example, an absorbent fleece is suitable that has a hygroscopic action or that works together with a suitable hygroscopic material, coated or impregnated with a suitable chemical element or chemical compound. The ink absorber 18 can also embody a specific absorbent foam. The foam, sponge, or fleece may be round or polygonal, or may be cut to any suitable shape. The ink absorber 18 encompasses any passively acting agent or material or chemical element or any chemical compound.

The ink absorber 18 can be realized in an arbitrary shape, and is situated at a distance from the cowling carriage 16 in the y direction, the holder being integrated into the cowling carriage 16 or being realized so as to be pluggable onto the cowling carriage 16. The ink dispenser need not be realized in the depicted specific embodiment; rather, it may also be realized alternatively, i.e. differently than shown or in modified form.

Although modifications and changes may be suggested by those skilled in the art, it is the intention of the inventor to embody within the patent warranted hereon all changes and modifications as reasonably and properly come within the scope of his contribution to the art.

I claim as my invention:

1. An ink dispensing device comprising:
a chassis configured to allow transport of items to be printed along an x-direction of a Cartesian coordinate system;
a print cartridge that carries an ink jet print head for printing on said items, and having a base plate with a stripper element integrally formed thereon, said print carriage being movable to a print position along a y-direction of said Cartesian coordinate system;
a wiping lip mount stationarily situated on said chassis, that carries wiping lips that clean said stripper element when said print carriage is moved from said print position in said y-direction;
a cowling carriage that carries at least one cowling that encloses said print head during cleaning thereof, said cowling carriage being mounted on said chassis for movement in the y-direction and a z-direction of said Cartesian coordinate system, said cowling carriage having an entraining hook and lateral guide pins;
an ink absorber in a holder mounted at a distance in the y-direction from a rear side of said cowling carriage, said stripper element of said print carriage being disposed opposite said ink absorber during a maintenance interval, in a position reached when a segment of said stripper element of said print carriage abuts said entraining hook of said cowling carriage;
said cowling carriage being configured to move toward and away from said print carriage in the z-direction with said lateral guide pins being guided in a slotted guide bar, while said print carriage is moved further; and
said ink absorber being configured to clean said stripper element during said movement of said cowling carriage by being pushed by said cowling carriage partially over said stripper element.

2. An ink dispensing device as claimed in claim 1 wherein said holder for said ink absorber is situated in a print path of said print head.

3. An ink dispensing device as claimed in claim 1 wherein said holder for said ink absorber is an integrated component of said cowling carriage.

4. An ink dispensing device as claimed in claim 1 wherein said holder for said ink absorber is a separate assembly that is mechanically coupled to said cowling carriage.

5. An ink dispensing device as claimed in claim 1 comprising two print heads carried by said print carriage, each having a print path, and wherein said ink absorber comprises respective sponges in said holder, offset from each other in the x-direction.

6. An ink dispensing device as claimed in claim 5 wherein each sponge is comprised of an ecologically degradable, synthetic material.

7. An ink dispensing device as claimed in claim 5 wherein said printing carriage is configured to move into a sealing position, opposite said cowling carriage, at which said print head is sealed by a cowling carried by said cowling carriage, while simultaneously causing said two sponges to be respectively situated opposite respective segments of said stripper, each stripper segment being situated next to a center segment of said stripper element, said center segment of said stripper element forming a stop on said entraining hook, and said stripper segments of said stripper element being formed as doctor blades.

8. An ink dispensing device as claimed in claim 5 wherein said holder comprises brackets respectively allocated to the print paths of the print heads, each bracket having a cavity matched in dimensions to the dimensions of the ink absorbing element allocated thereto.

9. An ink dispensing device as claimed in claim 1 wherein said holder for said ink absorber is a separate assembly that is mechanically coupled to said cowling carriage, said holder comprising a clip connected at both ends to respective brackets and, in said y-direction, having a slot with a width corresponding to a fitness of said entraining hook and having a length corresponding to a length of said entraining hook, said clip limiting a length of said slot at one end in the y-direction, and said slot having an opposite open end for coupling to said cowling carriage, said open end having a funnel-shape, and said brackets or said slot having an extent in the z-direction corresponding to a height of the entraining hook, and the closed end of the slot having a hook-shaped claw integrally formed at an underside of the clip, said claw being supported on a wedge-shaped surface at an underside of the chassis during coupling to the cowling carriage, each bracket having an edge that is smooth at an external side thereof and having pin-shaped bars at an inner side forming holding elements, and respective coupling elements being integrally formed on exterior of said smooth edge of said brackets, opposite the coupling elements in the y-direction, and being matched and shaped to a shape of the cowling carriage.

10. An ink dispensing device as claimed in claim 9 wherein said coupling elements are matched to lateral corners of the rear wall and to an upper edge of the sidewalls of the cowling carriage.

11. An ink dispensing device as claimed in claim 10 wherein said coupling elements form a snap-like connection.

12. An ink dispensing device as claimed in claim 9 wherein said holder comprises holding elements that allow exchangeable retention of said ink absorber.
